(19) United States
(12) Patent Application Publication
(10) Pub. No.: US 2011/0305238 A1
(43) Pub. Date: Dec. 15, 2011

(54) COMMUNICATION APPARATUS FOR HOSTED-PBX SERVICE

(75) Inventors: Junzo IKUTA, Fukuoka (JP); Toshihiko SAKATA, Fukuoka (JP); Eiji SAWADA, Fukuoka (JP)

(73) Assignee: PANASONIC CORPORATION, Osaka (JP)

(21) Appl. No.: 13/158,650

(22) Filed: Jun. 13, 2011

Related U.S. Application Data
(60) Provisional application No. 61/354,830, filed on Jun. 15, 2010.

(51) Int. Cl. H04L 12/66

(52) U.S. Cl. 370/352

(57) ABSTRACT

A communication apparatus is provided for relaying an IP telephony service provided by a PBX server to extension telephones. The communication apparatus includes: a memory unit which stores a user-ID/Subscriber definition table in which a user-ID preassigned to each of the extension telephones is associated with a user password and a subscriber number of the PBX server which is available by the user-ID; and a portal controller which has a Web server function for providing the PCs with a portal service, and processes portal data from the PCs and the PBX server. The portal controller determines, in accordance with a user-ID and a user password which are entered from the PC, a subscriber number to be used by the user-ID, records an access state to the portal service into a portal service access table, and associates the extension telephone that corresponds to the user-ID with the portal service.

### CROSS REFERENCE TO RELATED APPLICATIONS

This application claims the benefit of U.S. Provisional Application No. 61/354,830 filed on Jun. 15, 2010 with the United States Patent and Trademark Office, the contents of which are incorporated herein by reference.

### BACKGROUND OF THE INVENTION

1. Field of the Invention

The present invention relates to a communication apparatus, which is connected to a hosted PBX (IP-PBX or IP-Centrex) that provides an IP telephony service through an IP network, to provide extension telephones in an office with a telephony service and various portal services from a hosted PBX.

2. Background Art

PBXs (private branch exchanges) have been installed as an in-house telephone-switch in many companies up to today. Recently, by reason of the progress of IP telephony using VoIP (voice over IP) technology and the reduction of maintenance/administration costs for the in-house PBXs, the number of installing the in-house PBXs has been decreased gradually. Instead of the in-house PBXs, the hosted PBX services that an internet telephony service provider (ITSP) provides through the Internet, have been utilized in more companies.

As services provided by the hosted PBX, in addition to an existing voice call service, it becomes possible to use various portal services from a PBX server also having CTI (computer telephony integration) server function such as click-to-call or the like, which can call to a desired party without dial-operation, by referring to various data, such as a contact-list, a call-log etc, provided on the ITSP using a browser of a PC (personal computer) in an office or by associating the data with an extension telephone in the office through a simple click operation on a browser screen of the PC.

Further, it is possible to share one subscriber number in a plurality of extension telephones by installing an IP-key telephone system (IP-KTS) that is connectable to the IP-based outside lines, making the outside line of the IP-KTS correspond to the subscriber numbers of the hosted-PBX, setting a ring-tone of the outside line for each extension telephone, and simultaneously performing ringing for the plurality of extension telephones when the call to a specified subscriber number is received. Accordingly, the number of outside lines (subscriber numbers) is reduced, and the communication cost is further reduced.

However, if a portal service, such as click-to-call etc, that is provided by the hosted-PBX, is used in a case where the IP-KTS is installed between the hosted-PBX server and the extension telephones in the office and one subscriber number of the hosted-PBX server is shared in the plurality of extension telephones, the hosted-PBX server cannot recognize which extension telephone uses the portal service since the hosted-PBX server manages only the call state based on the subscriber number. Accordingly, for example, in the case of the click-to-call service, if the PC located at the office performs the click-to-call operation, the call-back call from the hosted-PBX server side is made, and then the IP-KTS controls the incoming call to not only the extension telephone of the click-to-call operator, but also to other extension telephones. As described above, the portal service provided by the hosted-PBX server causes inconvenience to the users, and is practically unacceptable.

### SUMMARY OF THE INVENTION

The present invention has been made in consideration of the above-described problems in the background art, and an object of the present invention is to provide a communication apparatus, which makes a portal service that is provided by a hosted-PBX server be convenient for a user even in the case where one subscriber number of the hosted-PBX is commonly used by a plurality of extension telephones.

A communication apparatus according to an aspect of the invention is adapted to relay an IP telephony service provided by a PBX server to extension telephones. The communication apparatus includes: an IP network interface for performing data communication with the PBX server; an extension line interface for performing data communication with the plurality of extension telephones; a LAN interface for performing data communication with a plurality of PCs; a server controller which analyzes message data transmitted from the PBX server, classifies the analyzed message data into a call control message for the extension telephone and a portal service message for the PC, and transmits messages from the plurality of PCs and extension telephones to the IP network interface; and a call controller which manages and controls a call state of the extension telephones.

The communication controller includes a memory unit which stores a user-ID/Subscriber definition table in which a user-ID (or an extension number) pre-assigned to each of the extension telephones is associated with a user password and a subscriber-ID (or a subscriber number) of the hosted-PBX server which is available by the user-ID, and a portal controller which has a Web server function for providing the PCs with a portal service, and processes portal data from the PCs and the hosted-PBX server. When a user utilizes the portal service of the hosted-PBX server, the portal controller determines, in accordance with a user-ID and a user password which are entered from the PC, a subscriber number to be used by the user-ID from the user-ID/Subscriber definition table, records an access state to the portal service into a portal service access table, and associates the extension telephone corresponded to the user-ID with the portal service of the hosted-PBX server.

Accordingly, the communication apparatus can recognize the correspondence between the subscriber numbers related to the portal service being currently in service and the extension telephones, and thus can perform call control on the target extension telephones in a portal service that is related to a phone call.

### BRIEF DESCRIPTION OF THE DRAWINGS

FIG. 1 is a configuration diagram of a hosted-PBX system that includes a communication apparatus according to an aspect of the present invention;

FIG. 2 is a functional block diagram of a communication apparatus according to a first aspect of the invention;

FIG. 3 is a functional block diagram of a communication apparatus according to a second aspect of the invention;

FIG. 4 is a table showing the contents of an extension definition table of a communication apparatus according to one embodiment of the invention;

FIG. 5a is a first example of contents of a subscriber password table of the communication apparatus according to the embodiment of the invention;

FIG. 5b is a first example of contents of a user-ID/Subscriber definition table of the communication apparatus according to the embodiment of the invention;

FIG. 6a is a second example of contents of a subscriber password table of the communication apparatus according to the embodiment of the invention;

FIG. 6b is a second example of contents of a user-ID/Subscriber definition table of the communication apparatus according to the embodiment of the invention;

FIG. 7 shows contents of a portal service access table of the communication apparatus according to the embodiment of the present invention;

FIG. 8 is a flowchart illustrating a login operation to a portal service of the communication apparatus according to the embodiment of the invention;

FIG. 9 is a flowchart illustrating a click-to-call operation of the communication apparatus according to the embodiment of the invention;

FIG. 10a is a diagram illustrating a portal screen (a screen transmitted by a PBX server) during login operation to the portal service of the communication apparatus according to the embodiment of the invention;

FIG. 10b is a diagram illustrating a portal screen (a screen transmitted by the communication apparatus to a PC) during login operation to the portal service of the communication apparatus according to the embodiment of the invention;

FIG. 10c is a diagram illustrating a portal screen (a screen when a user ID and a user password are entered) during login operation to the portal service of the communication apparatus according to the embodiment of the invention;

FIG. 11a is a diagram illustrating a portal service selection screen (a screen transmitted by the PBX server) of the communication apparatus according to the embodiment of the invention;

FIG. 11b is a diagram illustrating a portal service selection screen (a screen transmitted by the communication apparatus to the PC) of the communication apparatus according to the embodiment of the invention;

FIG. 12 is a diagram illustrating a contact-list screen of the communication apparatus according to the embodiment of the invention;

FIG. 13 is a diagram illustrating a call log list screen of the communication apparatus according to the embodiment of the invention; and

FIG. 14 is an example of a SIP call control message that is received from a PBX server when a call-back call is initiated by click-to-call in the communication apparatus according to the embodiment of the invention.

### DETAILED DESCRIPTION OF EXEMPLARY EMBODIMENTS

Hereinafter, an embodiment of the present invention will be described with reference to the drawings.

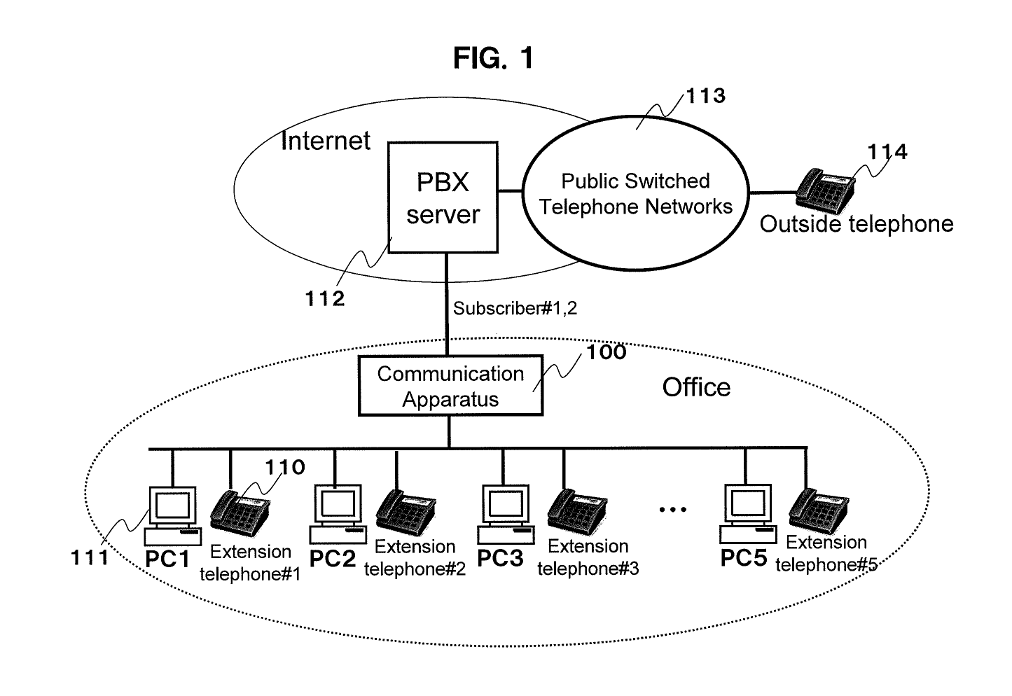

FIG. 1 is a configuration diagram of a hosted-PBX system that includes a communication apparatus according to an aspect of the present invention.

In FIG. 1, a communication apparatus 100 is installed in an office, and controls a plurality of extension telephones 110 and PCs 111 which are used by respective employees. Further, the communication apparatus 100 is connected to a PBX server 112 that provides an IP telephony service as a cloud computing service on the Internet. In general, the PBX server 112 is also called a hosted-PBX server, and may be a SIP (session initiation protocol) server supporting a call control protocol of an IP telephony, or be a call control server such as a gatekeeper supporting H.323 standardized in ITU-T. The PBX server 112 includes a server group composed of a web server that provides various portal services such as click-to-call, a data server that manages client data, and the like. The extension telephone 110 can make a phone call by dialing a phone number of an outside telephone 114 such as a fixed telephone or a mobile telephone which is connected to a public telephone network 113, or answer the incoming call from the outside telephone 114.

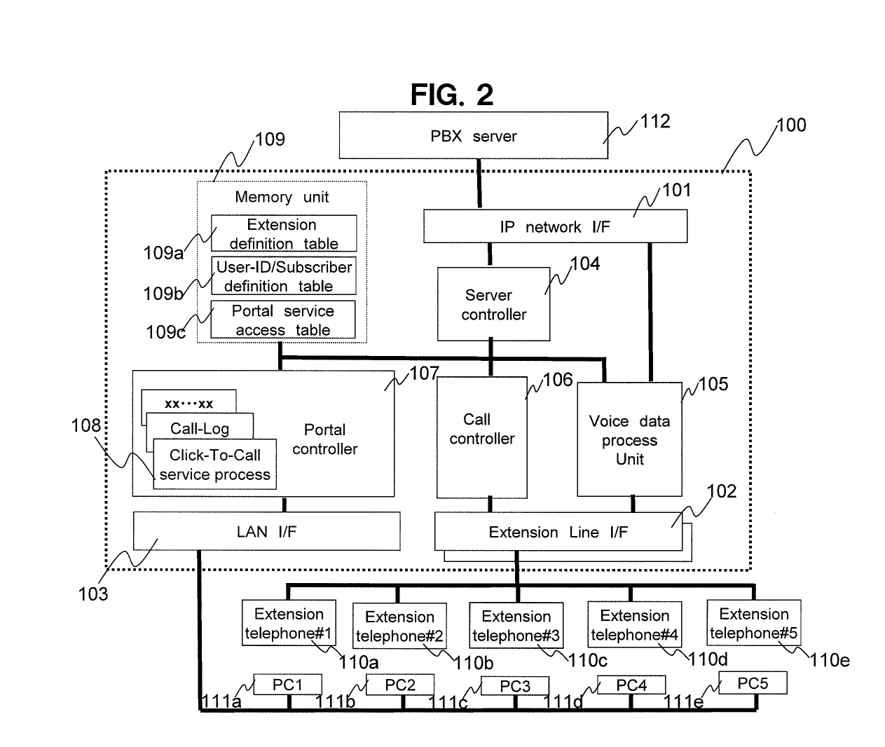

FIG. 2 is a functional block diagram of the communication apparatus 100 according to a first aspect of the invention.

An IP network interface (I/F) 101 includes a connector for connecting to a LAN cable or an ADSL/XDSL and a circuit that is necessary to connect to an IP network such as Ethernet. The IP network I/F 101 is connected to the PBX server 112 through the Internet or the like, and communicates call control data and voice packet data for an IP telephony service, and html data for a portal service with the PBX server 112.

An extension line I/F 102 is connected to extension telephones 110a to 110e. The extension telephones 110a to 110e may be digital multifunctional telephones, analog standard telephones, IP telephones, and the like that are used in the known PBX. In accordance with the kind of the extension telephones 110a to 110e, the extension line I/F 102 includes a circuit that is required for data communication with the telephones.

A LAN I/F 103 is connected to PCs 111a to 111e installed in the office through the LAN, and includes a connector for connecting to a LAN cable and a circuit that is required for data communication with the LAN such as the Ethernet.

A server controller 104 analyzes received data from the PBX server 112, and processes the received data by classifying the data into a call control message for the extension telephones 110a to 110e and a portal service message for the PCs 111a to 111e. Further, message data from the plurality of PCs 111a to 111e and extension telephones 110a to 110e is transmitted to the IP network I/F 101 through the server controller 104.

The voice data processing unit 105 includes a time-division switch for switching voice data received from the IP network and the extension telephones, or a soft-switch that performs switching RTP packet (voice data of VoIP) and establishes the voice path between the extension telephone and the IP network or between the extension telephones. In the case where the extension telephones 110a to 110e connected to the communication apparatus 100 are all IP telephones, the time-division switch is not necessary, and it is possible to configure the voice data processing unit 105 only with the soft-switch.

A call controller 106 processes the call control message from the extension telephones 110a to 110e and the PBX server 112, and manages the state of calls generated in the communication apparatus 100. The call controller 106 controls not only connection between the extension telephones and the PBX server, but also connection of a call between the extension telephones.

A portal controller 107 has a web server function that provides the PCs with a portal service. The portal controller 107 processes the portal data from the PCs 111a to 111e and the PBX server 112, and transmits the portal data to the PCs 111a to 111e. Further, the portal controller 107 may be provided with an additional service processing unit 108 that performs a unique process that is required to provide various portal services provided by the PBX server to the PCs 111a to 111e.

A memory unit 109 includes a volatile memory and a nonvolatile memory. The nonvolatile memory stores various kinds of program setting data that are required to be maintained even though the power of the communication apparatus 100 is turned off, and stores an extension definition table 109a and a user-ID/Subscriber definition table 109b therein. Further, the volatile memory stores a portal service access table 109c therein.

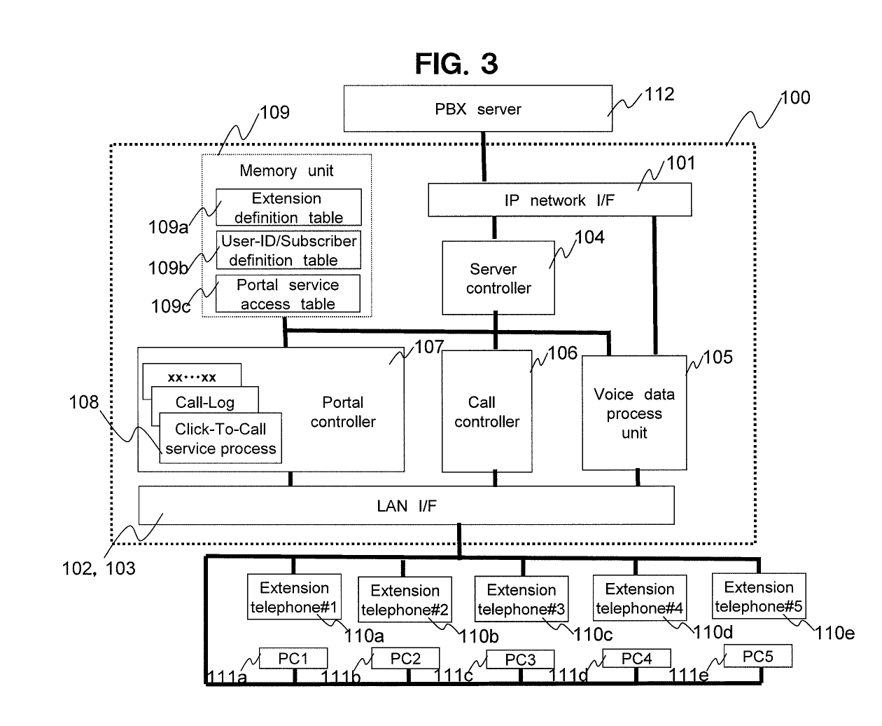

FIG. 3 is a functional block diagram of a communication apparatus 100 according to a second aspect of the invention. In the case where the extension telephones 110a to 110e connected to the communication apparatus 100 are all IP telephones, it is possible to use the LAN I/F 103 instead of providing the extension line I/F 102.

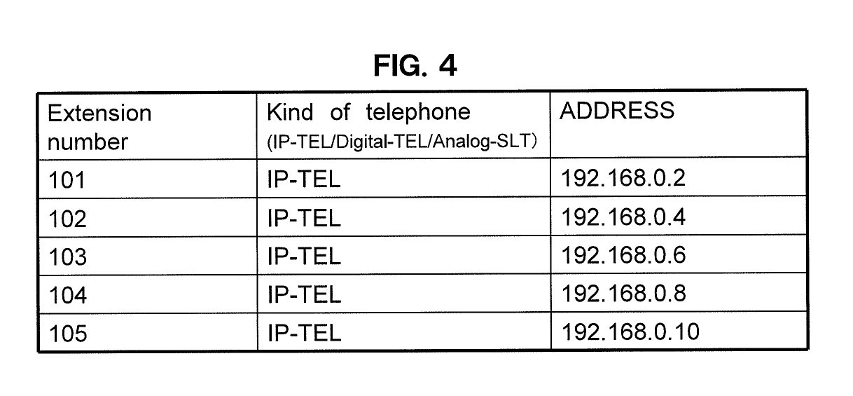

FIG. 4 shows contents of the extension definition table 109a of the communication apparatus 100 according to the embodiment of the invention. Extension numbers, kinds of extension telephone (IP telephone, digital multifunctional telephone, or analog standard telephone), and address information for accessing the extension telephones are defined in the extension definition table 109a. In the example of FIG. 4, five extension telephones 110a to 110e connected to the communication apparatus 100 are all IP telephones, and IP addresses of the IP telephones are defined in the address information.

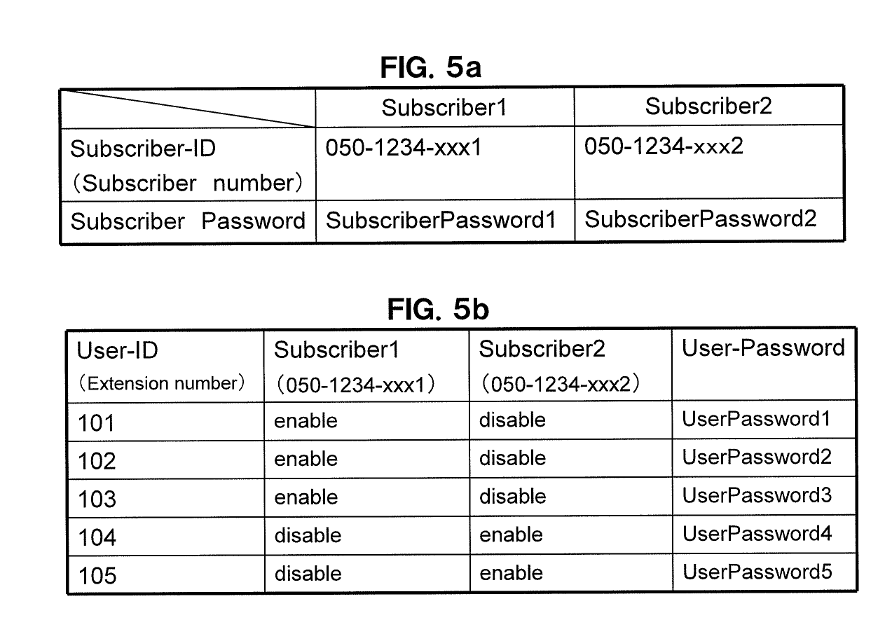

FIG. 5a and FIG. 5b illustrate contents of the user-ID/Subscriber definition table 109b in the communication apparatus 100 according to the embodiment of the present invention.

In FIG. 5a, subscriber numbers which are phone numbers predetermined in subscriber contract with the ITSP and subscriber passwords corresponding to the respective subscriber numbers are defined. In the embodiment of FIG. 5a, two subscriber numbers, that is, subscriber number 1 “050-1234-xxx1” and subscriber number 2 “050-1234-xxx2”, are enabled, and using these subscriber numbers, a telephony service with an extension telephone located in another remote office or the outside telephone 114 connected to PSTN (public switched telephone network) 113 is enabled. The subscriber number is used as calling party information or called party information in the call control message between the communication apparatus 100 and the PBX server 112. Further, in the case of using a portal service, the subscriber number is used as a login-ID. The subscriber password is uniquely defined for each subscriber number like a password generally used. The subscriber password is composed of English characters and numbers, etc. within a predetermined number of letters and is used as a login password of the portal service provided by the PBX server 112.

FIG. 5b illustrates the contents of the user-ID/Subscriber definition table 109b of the communication apparatus 100 according to the embodiment of the invention. In FIG. 5b, user-IDs (extension numbers) which are used by users of PCs and extension telephones and subscriber numbers which can be used by the users are defined. Further, user passwords, which are used when the users access the portal service provided by the communication apparatus 100, are defined.

In FIG. 5b, an example of a case where the user-ID is same as the extension number is illustrated. For example, the extension telephones 110a to 110c, of which the user-IDs (extension numbers) are “101” to “103”, indicate that subscriber number 1 “050-1234-xxx1” is enabled. If a call to subscriber number 1 is received from the PBX server 112 and the call controller 106 detects the call to the subscriber number 1, the call controller 106 searches the user-ID/Subscriber definition table 109b of FIG. 5b and performs receiving process to the three extension telephones 110a to 110c having the extension numbers “101” to “103” by which it is defined that subscriber number 1 is enabled.

Further, in the case of call operation from the extension telephone to the outside telephone 114 or the like, the call controller 106 confirms the use state of the subscriber numbers that can be used by the extension telephone in the order of subscriber numbers 1 and 2, and if a subscriber number in an empty state is detected, the call controller 106 performs the call operation in consideration of the corresponding empty subscriber number as calling party information with respect to the PBX server 112. By doing this operation, subscriber numbers, the number of which is smaller than the number of extension lines, can be commonly used for the plurality of extension telephones which are controlled by the communication apparatus 100.

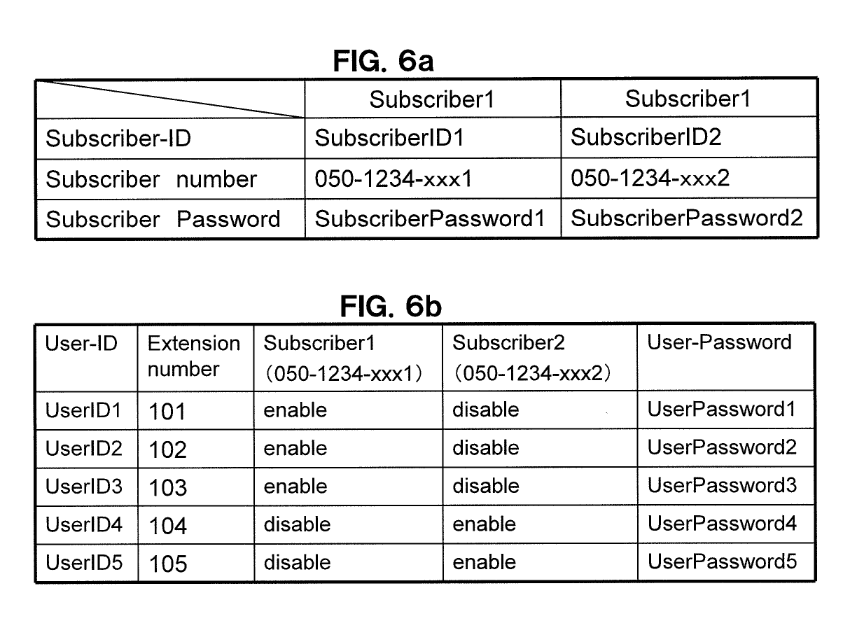

In FIG. 5a and FIG. 5b, the embodiment in which the extension numbers and the subscriber numbers, which are used as phone numbers, are used as login-IDs to the portal service provided by the communication apparatus 100 and the PBX server 112 has been described. Alternatively, as illustrated in FIG. 6a and FIG. 6b which correspond to FIG. 5a and FIG. 5b, respectively, User-IDs and subscriber-IDs may be provided as portal service dedicated login-IDs, separately from the extension numbers and the subscriber numbers which are phone number information, and may be used as login-IDs to the portal service of the communication apparatus 100 and the PBX server 112.

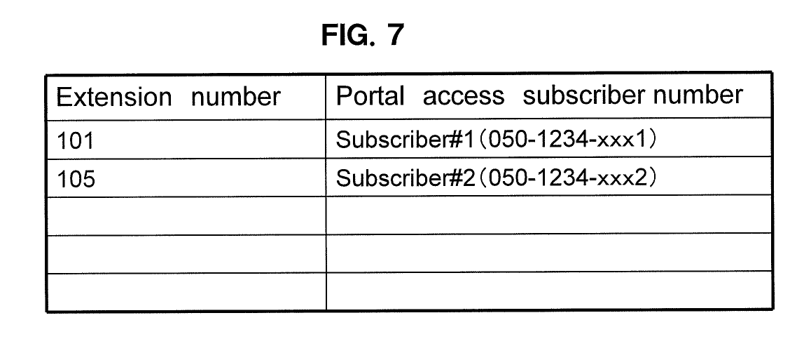

FIG. 7 illustrates the contents of the portal service access table 109c of the communication apparatus 100 according to the embodiment of the present invention. The portal service access table 109c is used to record user-IDs (or extension numbers) and subscriber-IDs (or subscriber numbers) which are related to the portal service when the portal service that is provided from the PC to the PBX server 112 is used. When the user logs into the portal service of the PBX server 112 from the PC through the communication apparatus 100, they are recorded, whereas when the user logs out or the disconnection of communication with the PC, they are deleted.

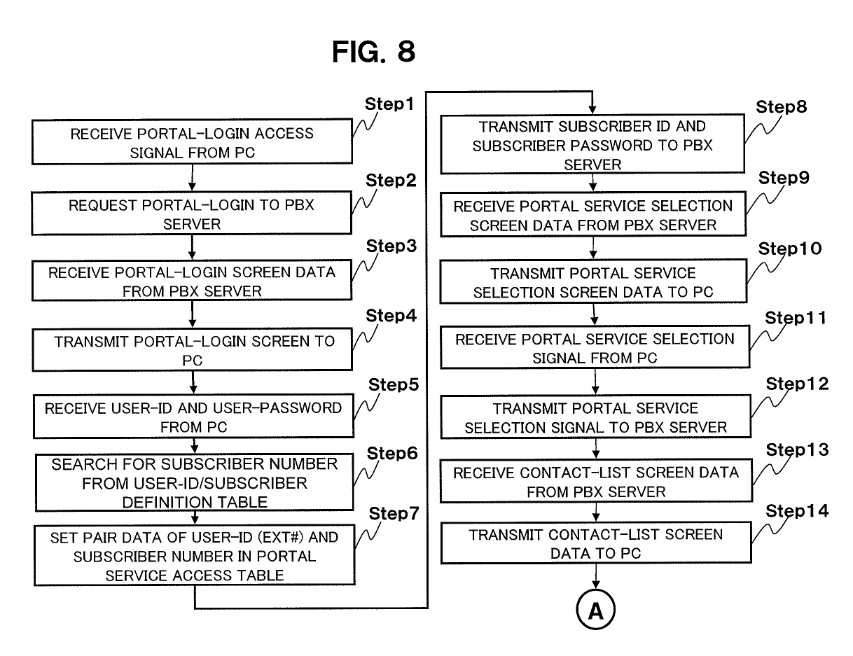

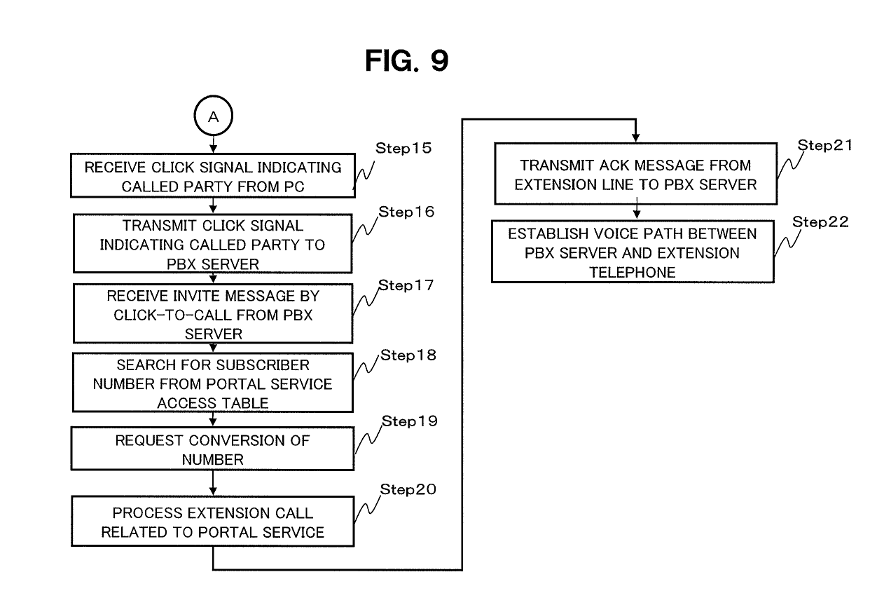

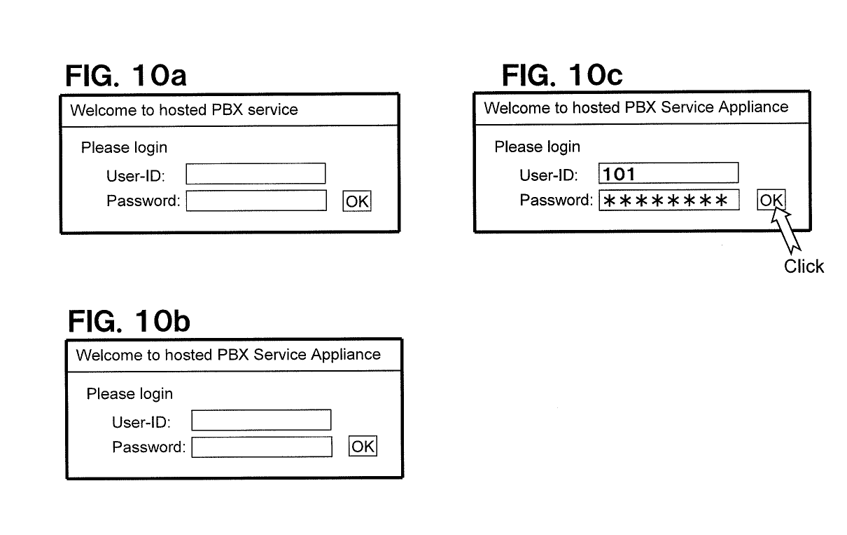

The operation of the communication apparatus 100 as configured above according to the embodiment of the invention, which performs login to the portal service of the PBX server 112 from PC1 111a through the communication apparatus 100, and performs click-to-call operation using the contact-list portal service, will be described with reference to the functional block diagram of FIG. 2, the contents of browser screens of FIG. 10a to FIG. 13, and the flowcharts of FIG. 8 and FIG. 9.

First, if the user accesses the portal service by inputting an URL address of the portal service of the communication apparatus 100 through a browser of the PC1 111a used by the user, the portal controller 107 receives a portal-login access signal through the LAN I/F 103 from the PC1 111a (step 1).

The portal controller 107 transmits the portal-login access signal (URL address for the portal service of the PBX server) to the PBX server 112 through the server controller 104 and requests portal-login to the PBX server 112 (step 2).

When the PBX server 112 receives the portal-login access signal, the PBX server 112 transmits portal-login screen data (FIG. 10a) of the PBX server 112 to the communication apparatus 100.

When the server controller 104 receives the portal-login screen data through the IP network I/F 101, the communication apparatus 100 determines that the data received from the IP network is message data of the portal service, and transmits the portal-login screen data to the portal controller 107 (step 3).

Here, the screen data transmitted by the communication apparatus 100 and the PBX server 112 is source program information described in HTML (Hyper Text Markup Language), and data communication is performed using HTTP (Hyper Text Transfer Protocol).

The portal controller 107 converts the screen data into portal-login screen data (FIG. 10b) that is provided by the communication apparatus 100, and transmits the portal-login screen data to the PC1 111a through the LAN I/F 103 (step 4).

When the portal-login screen (FIG. 10b) is displayed on the browser of the PC1 111a, the user enters a user-ID and a user password. For easy understanding of the following description, an example in which the extension number used by the user defined in the user-ID/Subscriber definition table 109b illustrated in FIG. 5b is used as the user-ID to be entered is described. Alternatively, the user-ID, which is independently set without making the user-ID coincide with the extension number as illustrated in FIG. 6b, may be entered.

When the user enters a user-ID “101” and a user password “UserPassword1” on a portal-login screen (FIG. 10b) that is displayed on the browser screen of PC1 111a, and clicks the “OK” (FIG. 10c), the user-ID and the user password are transmitted to the communication apparatus 100, and the portal controller 107 receives the user-ID and the user password from the PC1 111a (step 5).

The portal controller 107 confirms whether the received user-ID “101” and user password “UserPassword1” are correct by searching the user-ID/Subscriber definition table 109b (FIG. 5b) (step 6). Further, the portal controller 107 confirms an enabled subscriber number “050-1234-xxx1” that corresponds to the user-ID “101”, and extracts a subscriber password “SubscriberPassword1” by searching the user-ID/Subscriber definition table 109a (FIG. 5a).

The portal controller 107 records the extension number “101” and the subscriber number “050-1234-xxx1” that correspond to the user-ID “101” by which the user has accessed the portal service in the portal service access table (FIG. 7) (step 7). At this time, if the extension number “101” has already been recorded in the portal service access table, screen data that indicates login refused is transmitted to the PC1 111a to avoid the multiple login.

The portal controller 107 transmits the subscriber-ID “050-1234-xxx1” and the subscriber password “SubscriberPassword1” which are information required for the portal service login to the PBX server 112 through the server controller 104 (step 8). Here, although it is exemplified that the subscriber number “050-1234-xxx1” is transmitted to the PBX server 112 as the subscriber-ID, an independent subscriber-ID “SubscriberID1” which is determined between the communication apparatus 100 and the PBX server 112 as illustrated in FIG. 6a may be transmitted. This depends on the login specifications of the PBX server side.

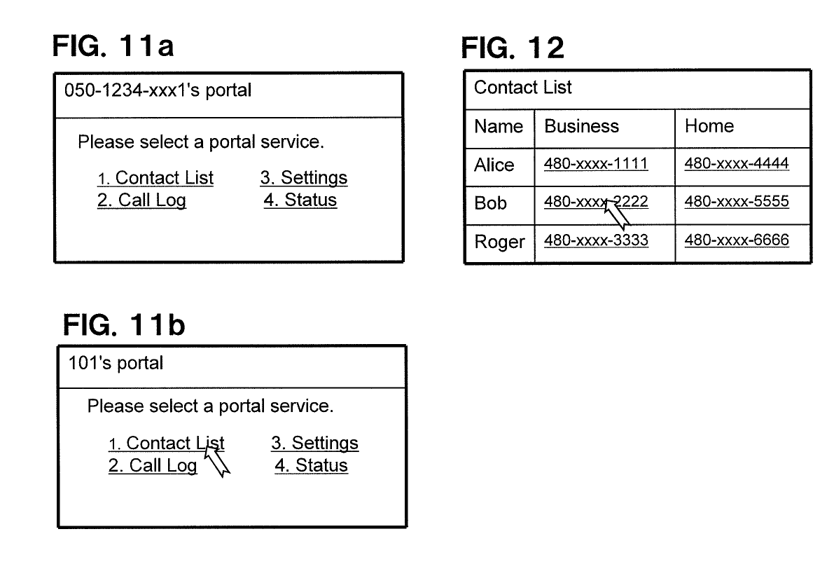

The PBX server 112 receives the subscriber-ID that is the login-ID to the portal service of the PBX server 112 from the communication apparatus 100 and the subscriber password that is the login password. If their comparison result is correct, it returns its response screen data to the communication apparatus 100. In this embodiment of the invention, various portal service names are described as response screen data, and by clicking the portal service name, portal service selection screen data (FIG. 11a), from which a service can be selected, is transmitted to the communication apparatus 100. The portal service selection screen data reaches the portal controller 107 through the above-described procedure as described in step 3 (step 9).

The portal controller 107 transmits an HTML source program that is the received portal service selection screen data (FIG. 11a) to the PC1 111a (step 10).

The portal controller 107 may replace the subscriber number of the portal service selection screen data (FIG. 11a) with the user-ID (extension number), as illustrated in the portal service selection screen data (FIG. 11b), and may transmit the data to the PC1 111a. Accordingly, the user can use the portal service of the PBX server 112 without being conscious of the subscriber number.

The PC1 111a displays a portal service selection screen (FIG. 11b) on a browser, and when a contact-list that corresponds to the portal service names to be used is selected by clicking the portion “1.Contact-List” of the portal service selection screen, it transmits a portal service selection signal for the contact-list service to the communication apparatus 100, and thus the portal controller 107 receives the portal service selection signal for the contact-list service (step 11).

The portal controller 107 transmits the portal service selection signal for the contact-list service to the PBX server 112 through the server controller 104 (step 12).

When the PBX server 112 analyzes the portal service selection signal and detects that the contact-list service has been selected, it edits the contact-list screen data illustrated in FIG. 12 from the contact-list data of the subscriber number 1 in a database inside the server, and transmits the contact-list screen data to the communication apparatus 100.

The portal controller 107 receives the contact-list screen data transmitted by the PBX server 112 through the server controller 104 (step 13).

The portal controller 107 transmits the received contact-list screen data to the PC1 111a (step 14).

As described above, in the flow from step 1 to step 14, the PC1 111a operates to execute the login to the portal service of the PBX server 112 through the communication apparatus 100 and to access the contact-list portal service.

The click-to-call operation of the PC1 111a, in which the user of the PC1 111a clicks a portion “480-xxxx-2222” on the contact-list screen (FIG. 12), will be described hereinafter according to the flowchart of FIG. 9.

When the user of the PC1 111a clicks the phone number “480-xxxx-2222” on the contact-list screen (FIG. 12), the portal controller 107 receives a click signal that indicates that the portion “480-xxxx-2222” of the contact -list screen has been clicked from the PC1 111a (step 15).

The click-to-call processing unit 108 of the portal controller 107 detects that the portion “480-xxxx-2222” of the contact-list screen of the PBX server has been clicked by analyzing the click signal, and transmits the click signal indicating that the portion “480-xxxx-2222” of the contact-list screen received from the PBX server 112 has been clicked to the PBX server 112 (step 16). In this case, the click signal transmitted to the PBX server 100 is the same as the click signal that is generated when the PC 1 directly accesses the PBX server 112 without passing through the communication apparatus 100 and performs clicking with reference to the contact-list screen from the PBX server 112.

When the click signal indicating that the portion “480-xxxx-2222” has been clicked is received, the PBX server 112 activates a call-back call to the communication apparatus 100 that is the click-to-call caller.

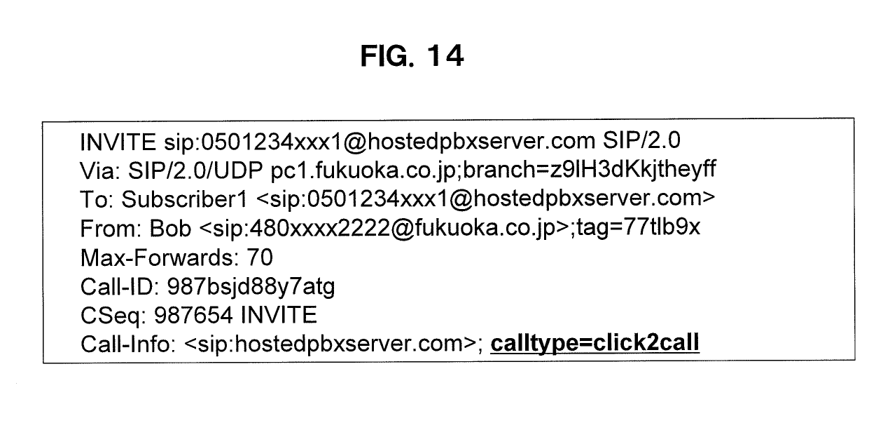

Further, the call-back call of the click-to-call that is transmitted from the PBX server 112 to the communication apparatus 100 is performed in a manner that an invite message illustrated in FIG. 14 is transmitted in the case where the SIP has been applied as the call control protocol between the PBX server 112 and the communication apparatus 100. In this invite message, a value “click2call” that indicates the call-back call by the clock-to-call as a specified identifier of the header information of the message, for example, a call type identifier, is set, and by this, it can be identified whether the invite message is a normal incoming call or the call-back call by the click-to-call.

Further, in the case where H.323 instead of the SIP has been applied as the call control protocol between the PBX server 112 and the communication apparatus 100, a value that indicates the call-back call by the click-to-call as the information element of a setup message may be defined.

The communication apparatus 100 receives the invite message that indicates the call-back call by the click-to-call from the PBX server 112 (step 17).

The server controller 104 confirms whether the call type identifier of the received invite message is a value “click2call” that indicates the call-back call by the click-to-call, and if the call type identifier corresponds to the call-back call by the click-to-call, the server controller 104 determines that the call control message is for the call which is associated with the portal service, and acquires the extension number “101” that corresponds to the subscriber information “050-1234-xxx1” that is the called party information of the invite message by searching the portal service access table (FIG. 7) (step 18).

The server controller 104 requests the call controller 106 to perform the incoming call process whereby the called party information of the received invite message is converted from the subscriber number “050-1234-xxx1” to the extension number “101” (step 19).

The call controller 106 which is requested to perform the incoming call process and the conversion into the extension number “101” confirms that the kind of the extension telephone #1 110a in the callee is an IP telephone and its IP address is “192.168.0.2” by searching the extension definition table 109a (FIG. 4), and performs a incoming call process of the extension telephone #1 110a (step 20).

In this call process, the invite message, in which the called party information of the invite message that is received from the PBX server 112 has been converted into the extension number “101”, is transmitted to the extension telephone #1 110a that is an IP telephone. The extension telephone #1 110a that has received the invite message performs the ringing by the call-back call of the click-to-call.

When the extension telephone #1 110a that is in a call-back ringing state is off-hooked, an acknowledge message is transmitted to the communication apparatus 100.

When the call controller 106 of the communication apparatus 100 receives the acknowledge message from the extension telephone #1 110a, it transmits the acknowledge message, in which the response from the extension telephone #1 110a has been converted into the subscriber number 1, to the PBX server 112 (step 21).

Thereafter, the PBX server 112 which has received the acknowledge message establishes a voice path between the outside telephone and the extension telephone #1 110a after calling the outside telephone that is the click-to-call caller, and thus the extension telephone #1 110a and the outside telephone are in a talking state (step 22).

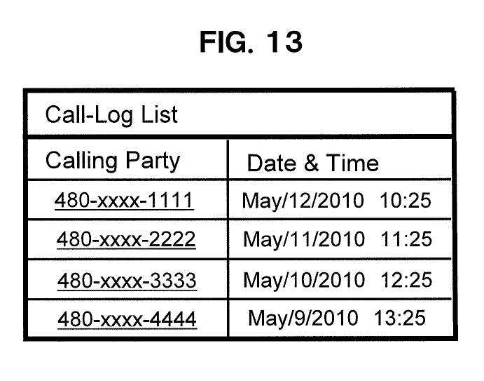

As described above, although the click-to-call operation of the user PC from the contact-list screen that is provided by the PBX server 112 has been described, the call origination by the click-to-call operation from a call-log screen illustrated in FIG. 13 is possible even in the call-log service that refers to the call-log information which the PBX server 112 provides for each subscriber.

As described above, the communication apparatus 100 according to the aspects of the present invention can reduce the communication cost by reducing the number of subscriber numbers of the hosted-PBX service, and also can make the telephony service and the portal service of the hosted-PBX server as services improving usability.

Further, in the embodiment of the invention, although the operation form in the case where the communication apparatus is connected to the hosted-PBX server has been described, the present invention is not limited to the configuration of the system that is called the hosted-PBX on the ITSP side and the communication apparatus inside the office, and it is also possible to arrange and utilize the communication apparatus according to the present invention between the IP-PBX in the background art that is arranged inside the office and the extension telephones.

What is claimed is:

1. A communication apparatus for relaying an IP telephony service provided by a PBX server to a plurality of extension telephones, the communication apparatus comprising:
an IP network interface to be connected to the PBX server through an IP network to perform data communication with the PBX server;
an extension line interface for performing data communication with the plurality of extension telephones;
a LAN interface for performing data communication with a plurality of PCs;
a server controller which analyzes message data transmitted from the PBX server, classifies the analyzed message data into a call control message for the extension telephone or to a portal service message for the PCs, and transmits messages from the plurality of PCs and extension telephones to the IP network interface;
a call controller which processes the call control message from the extension telephone and the PBX server;
a memory unit which stores a user-ID/Subscriber definition table in which a user-ID preassigned to each of the extension telephones is associated with a user password and a subscriber number of the PBX server which is available by the user-ID; and
a portal controller which has a Web server function for providing the PCs with a portal service, and processes portal data from the PCs and the PBX server, wherein
the portal controller selects, in accordance with a user-ID and a user password which are entered from the PC, a subscriber number to be used by the user-ID from the user-ID/Subscriber definition table, records an access state to the portal service into a portal service access table, and associates the extension telephone corresponded to the user-ID with the portal service of the PBX server.

2. The communication apparatus according to claim 1, wherein
the portal controller allows a user to log in the portal service of the PBX server by transmitting a subscriber-ID and a subscriber password to the PBX server when the portal controller selects, in accordance with the user-ID and the user password which are entered from the PC, the subscriber-ID to be used by the user-ID from the user-ID/Subscriber definition table.

3. The communication apparatus according to claim 1, wherein
when the server controller has received the call control message which is related to the portal service from the PBX server, the server controller acquires the user-ID that corresponds to the subscriber number contained in the call control message by referring to the portal service access table, and the received call control message is processed as a call control message to the extension telephone that corresponds to the acquired user-ID.

4. The communication apparatus according to claim 3, wherein
the call control message is a SIP message, and the server controller determines the SIP message as the call control message which is related to the portal service in a case where a header of the SIP message includes a specific identifier which indicates a relation with the portal service.

5. The communication apparatus according to claim 4, wherein
if the portal controller allows a user to log in the portal service, and a click-to-call service is selected as the portal service,
when the server controller has received an invite message of the SIP message from the PBX server after an operation of calling a party on a contact list screen in the click-to-call service, the server controller acquires the user-ID that corresponds to the subscriber number contained in the invite message by referring to the portal service access table, and the received invite message is processed as a call-back call to the extension telephone that corresponds to the acquired user-ID.

6. The communication apparatus according to claim 1, wherein
an extension number assigned to the extension telephone is used as the user-ID.
